(19) United States
(12) Patent Application Publication
(10) Pub. No.: US 2007/0083323 A1
(43) Pub. Date: Apr. 12, 2007

(54) Personal cuing for spatially associated information

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/425,981

(22) Filed: Jun. 22, 2006

Related U.S. Application Data
(60) Provisional application No. 60/724,469, filed on Oct. 7, 2005.

(51) Int. Cl. G01C 21/00; G01S 1/00

(52) U.S. Cl. 701/200; 342/357.01

(57) ABSTRACT

A method and system provides sensory cues to a user via a portable computing device as they wander a physical space, alerting the user as to the presence of spatially associated information linked to a location that is within a proximity region defined around that user's then current physical location. The size and/or shape of the proximity region can be defined in accordance with the speed and/or direction of motion of the user.

This application claims the benefit of U.S. Provisional Application No. 60/724,469, filed Oct. 7, 2005, which is incorporated in its entirety herein by reference.

Additionally, this application relates to the following co-pending U.S. Patent Applications, all of which are incorporated herein by reference:

U.S. application Ser. No. 11/315,755, of Rosenberg, filed Dec. 21, 2005 and entitled “METHOD AND APPARATUS FOR ACCESSING SPATIALLY ASSOCIATED INFORMATION”; and

U.S. application Ser. No. 11/344,701, of Rosenberg, filed Jan. 31, 2006 and entitled “TRIANGULATION METHOD AND APPARATUS FOR TARGETING AND ACCESSING SPATIALLY ASSOCIATED INFORMATION”.

### BACKGROUND

1. Field of Invention

Embodiments exemplarily described herein relate generally to the storage and access of information based upon geographic positions. Additionally, embodiments exemplarily described herein relate to methods and systems adapted to alert users when they come within a certain proximity (e.g., as defined by a proximity region) of a geographic position for which information is associated. Additionally, embodiments exemplarily described herein relate to methods and systems adapted to define the proximity region around a user for which alerts are generated.

2. Discussion of the Related Art

Many people wander about the physical world without realizing the wealth of information concerning their surroundings. For example, people travel in their own communities without knowing what buildings may be of historical significance or what shopping center may have a specific store or whether any store in the shopping center sells a specific product. In addition, the natural world is abundant with location-related information that would be of interest to people—the names of particular trees, plants, landforms, bodies of water, and other natural landmarks that are fixed in location. In many instances, people rely on maps, field guides, brochures or other literature in order to familiarize themselves with their surroundings. These documents may include tourist/travel brochures, shopping mall directories/maps, park field guides or naturalist books, or other similar literature. However, these documents are not very informative because they contain limited amounts of information and are generally not useful on the fine identification of objects such as specific trees and plants. Also, such printed information is generally not kept up-to-date as well as on-line information.

This lack of information often results in ineffective advertising for businesses and limited scientific information about natural phenomenon. For example, on a traditional map or brochure covering a city, business are not be able to provide the consumer with a list of products sold in a particular store nor can businesses indicate products that are currently on sale or otherwise featured. On a traditional map or guide covering a park, information can not be given that identifies the type and age and factual information associated with individual trees. Similarly, a local historical building may not be able to provide the public with detailed historical information concerning the significance of the site.

However, many entities, such as stores, parks, historical sites, and/or businesses now utilize distributed networks, such as the Internet and, more particularly, the World Wide Web portion of the Internet, to provide the public with useful information. For example, information about a historical site, such as a battlefield, may be disseminated via the World Wide Web and accessed though commercial Internet service providers (ISPs). The World Wide Web also provides the public with countless amounts of other information, such as business data, stock quotes or official government information.

However, a user will not have access to the desired information unless they manually input a web address or uniform resource locator (URL) associated with a particular web page. In these cases, it may be difficult to retrieve the web page because the URL may be unknown and/or difficult to locate, even with the sophisticated search engines currently available. Also, the web address may be very long which may result in a mistake when entering the web address. Also in many cases the user may be at a location and looking at an object in the distance, such as a tree or building or river or lake or hill or valley or outcropping of rock and may not know what kind of tree it is, what building it is, what the name or the river is, what the name of the lake is, how tall the hill is, what the name of valley is, or what kind of outcropping of rock it is. All the user may know is that the object is located within their field of view, some distance away at a particular orientation. In such a circumstance, the user may not know how to search for a URL that would provide information about the particular tree or building or river or lake or hill or rock other object that they are then looking at and wondering about.

A number of prior art systems have been developed for accessing spatially associated information, the information being accessed based upon the then current location of a portable computing system as determined by one or more Global Positioning System (GPS) sensor local to a computing system. An early implementation of such a system is described in the paper by Spohrer entitled Information in Places and published in IBM Systems Journal, vol. 38, No. 4,1999 (p. 602-628), which is hereby incorporated by reference. Moreover, U.S. Pat. No. 6,122,520 entitled SYSTEM AND METHOD FOR OBTAINING AND USING LOCATION SPECIFIC INFORMATION, and hereby incorporated by reference, describes a system that uses Navstar Global Positioning System (GPS), in combination with a distributed network, to access location related information based upon GPS coordinates. In addition, U.S. Pat. No. 6,819,267 entitled SYSTEM AND METHOD FOR PROXIMITY BOOKMARKS USING GPS AND PERVASIVE COMPUTING, and hereby incorporated by reference, also describes a system for accessing location related information using GPS coordinates. In addition U.S. Patent Application Publication No. 2005/0032528, entitled GEOGRAPHICAL WEB BROWSER, METHODS, APPARATUS AND SYSTEMS, and hereby incorporated by reference, also describes a system for accessing location related information using GPS coordinates.

The problem with such systems is that they generally assume a user knows where the information is stored that he or she desires and that the user actively goes looking for the information. There are many situations in which a user may simply be walking about a physical place and may pass by or near physical locations that are linked to information that he or she may be interested in finding. For example a virtual post-it note might be positioned freely in space at a location that the user would not even think of checking. Thus, while conventional systems provide certain important features, they lack the ability to provide effective real-time alerts to users as they walk about a physical space, the real time alerts being provided to inform the user that they have come within a certain proximity of a piece of spatially associated information that they may be interested in and/or a piece of information that is specifically relevant to them personally.

### SUMMARY

Several embodiments exemplarily described herein address the needs above as well as other needs by providing methods and systems adapted to provide personal cuing for spatially associated information.

One embodiment exemplarily described herein can be characterized as a cuing method that includes steps of receiving current locative data, the locative data identifying a geographic position of a user's portable computing device and a direction of motion of the portable computing device; defining a shape of a proximity region around the geographic position according to the direction of motion of the portable computing device; accessing a database containing a plurality of information files, each of the plurality of information files being linked with a location; determining whether a location to which an information file is linked is within the proximity region; and transmitting a message to the portable computing device when a location linked to an information file is within the proximity region. The message may be adapted to alert a user via the portable computing device as to the presence of the information file.

Another embodiment exemplarily described herein can be characterized as a cuing method that includes steps of receiving current locative data, the locative data identifying a geographic position of a user's portable computing device and a speed of motion of the portable computing device; defining a size of a proximity region around the geographic position according to the speed of motion of the portable computing device; accessing a database containing a plurality of information files, each of the plurality of information files being linked with a location; determining whether a location to which an information file is linked is within the proximity region; and transmitting a message to the portable computing device when a location linked to an information file is within the proximity region. The message may be adapted to alert a user via the portable computing device as to the presence of the information file.

Yet another embodiment exemplarily described herein can be characterized as a cuing system that includes circuitry adapted to: receive current locative data, the locative data identifying a geographic position of a user's portable computing device and a direction of motion of the portable computing device; define a shape of a proximity region around the geographic position according to the direction of motion of the portable computing device; access a database containing a plurality of information files, each of the plurality of information files being linked with a location; determine whether a location to which an information file is linked is within the proximity region; and transmit a message to the portable computing device when a location linked to an information file is within the proximity region. The message may be adapted to alert a user via the portable computing device as to the presence of the information file.

Yet another embodiment exemplarily described herein can be characterized as a cuing system that includes circuitry adapted to: receive current locative data, the locative data identifying a geographic position of a user's portable computing device and a speed of motion of the portable computing device; define a size of a proximity region around the geographic position according to the speed of motion of the portable computing device; access a database containing a plurality of information files, each of the plurality of information files being linked with a location; determine whether a location to which an information file is linked is within the proximity region; and transmit a message to the portable computing device when a location linked to an information file is within the proximity region. The message may be adapted to alert a user via the portable computing device as to the presence of the information file.

### BRIEF DESCRIPTION OF THE DRAWINGS

The above and other aspects, features and advantages of several embodiments exemplarily described herein will be more apparent from the following more particular description thereof, presented in conjunction with the following drawings.

FIG. 1 illustrates a schematic representation of one embodiment of a personal cuing systems;

FIG. 2 illustrates one embodiment of a portable computing device;

FIG. 3 schematically illustrates computational architecture associated with one embodiment of a portable computing device, in addition to a communication link with an SAI server; and

FIGS. 4A-4D and 4A-4C illustrate exemplary shapes and sizes of proximity regions, in accordance with numerous embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments exemplarily described herein. Also, common but well-understood elements that are useful or necessary in a commercially feasible embodiment are often not depicted in order to facilitate a less obstructed view of these various embodiments.

### DETAILED DESCRIPTION

The following description is not to be taken in a limiting sense, but is made merely for the purpose of describing the general principles of exemplary embodiments. The scope of the invention should be determined with reference to the claims.

According to numerous embodiments, personal cuing methods and systems are disclosed for storing and accessing digital information based upon spatial locations and/or spatial areas within the real physical world. A server is provided for linking accessible digital information to spatial locations and/or spatial areas within the real physical world. The server may be a single server, a network of servers, or a plurality of independently operated servers such that the servers provide associations between specific spatial locations and/or spatial areas within the in the real physical world and specific digital information content. As used herein, the term “spatially associated information server” is used to describe such a server that performs this function whether it be a single server, a network of servers, or a plurality of independently operated servers. Also as defined herein, a spatial location in the real physical world refers to a discrete location, usually defined by spatial coordinates, in the real physical world. As also defined herein, a spatial area refers to a range of locations that fall within certain boundaries or boarder within the real physical would and is usually defined as by a set of spatial coordinates and/or one or more spatial coordinates combined with a mathematical area or volume definition that is considered with respect to the one or more spatial coordinates. For example, a circular area of radius, r, may be defined around a particular spatial coordinate as a means of defining a spatial area. In common embodiments, spatial locations and/or spatial areas are defined using a global coordinate system of latitude values, longitude values, and optionally elevation values. In addition, spatial locations and/or spatial areas may be defined using directional values such as degrees away from magnetic north. Although these coordinates are most commonly used, other coordinate systems and/or locative conventions may be used to achieve the functionality of embodiments described herein. The spatially associated information server includes a digital memory for linking information files, to spatial locations and/or spatial areas within the real physical world. Such information files may include textual content, numerical content, image content, movie content, sound content, music content, and/or any other forms of information.

According to numerous embodiments, users may use one or more portable computing devices with wireless communication capabilities for accessing the spatially associated information server. The portable computing device also includes position sensing transducers for determining a current position of the portable computing device as the user moves about the real physical world. In common embodiments, the position sensing transducer is a GPS transceiver for determining current latitude, longitude, and optionally elevation coordinates for the portable computing device as the user of that device moves about the real physical world. The portable computing device may also include orientation sensing transducers for determining a current orientation of the portable computing device (or a portion thereof) as the user moves about the real physical world. The orientation sensing transducer may include, for example a magnetometer and/or an accelerometer for detecting orientation values. In general, orientation values are detected with respect to magnetic north and/or the direction of gravity. In addition, the portable computing device may be configured to store a time-history of positional values, the time-history of positional values being used by circuitry supported by the portable computing device and/or upon the spatially associated information server to determine a direction of motion and/or a rate of motion of the portable computing device as manipulated by the user as he or she moves about the real physical world.

According to numerous embodiments, the one or more portable computing devices and the spatially associated information server operate together to enable one or more users to access spatially associated information (e.g., in the form of information files) as the user(s) traverses the real physical world. For example, a user of a portable computing device equipped with a GPS sensor may be alerted to and selectively access information files linked to physical locations based upon their current physical location in the real world. For example, a user may be alerted to and provided selective access to information files linked to specific landmarks, businesses, historical places, parks, and/or other physical locations as that user visits, approaches, and/or nears in the real world. The information files may be text, images, videos, sounds, music, or other common forms of digitally stored media. In this way, a user may wander about the real world and be alerted to one or more information files that are linked to physical locations or areas within his or her proximity and be given selective access to that information. Such information files may be factual information provided by an organization, personal notes left by other wandering users, or other types and kinds of information that may be stored and accessed based upon spatially associated information. By providing this alerting function, a user may be informed as he or she wanders about a real physical space if information is stored at or near the particular location that he or she is currently visiting. For example, a user walking down a street or through a park may not know where along that street or in that park spatially associated information is linked. In one embodiment, a sensory cue may be provided to the user, informing the user that he or she has come within certain proximity of spatially associated information. For example, a variable sensory cue may be provided, wherein the form of the cue informs the user as to the presence, type, importance, relevance, and/or proximity of the spatially associated information that he or she is near.

Thus, numerous embodiments exemplarily disclosed herein offer a means of cuing users about the presence, type, importance, relevance, and/or proximity of the spatially associated information that he or she comes within certain proximity of. For example, embodiments described herein provide hardware and/or software that enable sensory cues to be imparted upon the user through visual and/or audio sensations. Alternately, sensory cues may be imparted upon the user through tactile sensations that are less likely to distract the user from his or her experience of the real physical world. In general, the user is looking and listening to the world around him or her and so visual and audio cues may be distracting and/or intrusive. Embodiments described herein therefore provide haptic hardware and software technologies that enable the selective presentation of tactile sensations to the user to inform the user as to the presence type, importance, relevance, and/or proximity of the spatially associated information that he or she comes within certain proximity of as he or she wanders a real physical space. Furthermore, some embodiments described herein select and provide a specific tactile sensation cue (also referred to herein as a tactile cue) from among a plurality of different and perceptually distinguishable tactile sensation cues. In some embodiments, the particular tactile cue is selected and imparted to alert the he user as to the presence of spatially associated information and to inform the as to the type of spatially associated information that has been encountered. In some embodiments, the particular tactile cue is selected and imparted to alert the user as to the presence of spatially associated information and to inform the as to the importance of spatially associated information that has been encountered. In some embodiments, the particular tactile cue is selected and imparted to alert the user as to the presence of spatially associated information and to inform the as to the relevance of spatially associated information that has been encountered to that particular user. In some embodiments, the particular tactile cue is selected and imparted to alert the user as to the presence of spatially associated information and to inform the as to the proximity of spatially associated information that has been encountered to that particular user. In some embodiments, the particular tactile cue is selected and imparted to alert to a combination of facts including two or more of the presence, type, importance, relevance, and/or proximity of the information. In addition, some embodiments provide a tactile alert that is conditionally imparted upon a user when that user comes within certain proximity of the location and/or area linked to a piece of spatially associated information, but only if that user is moving in a certain direction, moving below a certain speed, and/or is facing a certain direction. In this way, tactile alerts may be imparted depending upon both the proximity of the user to spatially associated information and a direction of motion, a speed of motion, and/or a facing direction.

In some embodiments, tactile cues of a selectable magnitude and/or frequency, the selected magnitude and/or frequency may be provided to inform the user as to the type of spatially associated information that is linked to locations that are within a certain proximity of that user's then current physical location. In some embodiments, tactile cues of a selectable magnitude and/or frequency, the selected magnitude and/or frequency may be provided to inform the user as to the importance of spatially associated information that is linked to locations that are within a certain proximity of that user's then current physical location. In some embodiments, tactile cues of a selectable magnitude and/or frequency, the selected magnitude and/or frequency may be provided to inform the user as to the relevance of spatially associated information to that particular user. Furthermore, in some embodiments, tactile cues of a selectable magnitude and/or frequency, the selected magnitude and/or frequency may be provided to inform the user as to the proximity of spatially associated information that is linked to locations that are near that user's then current physical location.

Furthermore, numerous embodiments discussed herein describe methods of defining a proximity region around a user within which spatially associated information triggers on that user's portable computing device an alert and/or is accessed by that user's portable computing device. As used herein, the term “proximity region” refers to a spatial area around a user's current location within which a spatial location (or at least a portion of a spatial area) that is linked to spatially associated information will trigger an alert for that user if determined to be relevant to that user. That is, a proximity region is a spatial area around a user's current location that is monitored such that if a piece of spatially associated information is linked to a spatial location that falls within the proximity region or is linked to a spatial area that overlaps with the proximity region, the user will be alerted (or will be conditionally alerted) to that piece of spatially associated information. On the other hand, if a piece of spatially associated information is linked to a spatial location that does not fall within the proximity region or is linked to a spatial area that does not overlap with the proximity region, the user will not be alerted (and not be conditionally alerted) to that piece of spatially associated information. As used herein, the phrase “conditionally alerted” means that the user will be alerted conditionally upon some other factor being satisfied. For example, a user may be conditionally alerted if a piece of spatially associated information (i.e., an information file) is linked to a location that falls within the current proximity region for that user and if that information file is of an importance level that is above a certain threshold. Similarly, a user may be conditionally alerted if a piece of spatially associated information is linked to a location that falls within the current proximity region for that user and if that piece of information is of an information type that the user has configured his preferences to trigger alerts for. Similarly, a user may be conditionally alerted if a piece of spatially associated information is linked to a location that falls within the current proximity region for that user and if that piece of information is specifically intended for that user as a result of a messaging tag that uniquely identifies that user. Similarly, a user may be conditionally alerted if a piece of spatially associated information is linked to a location that falls within the current proximity region for that user and if that user has access to the information by possessing a particular password or other means of authentication or authorization.

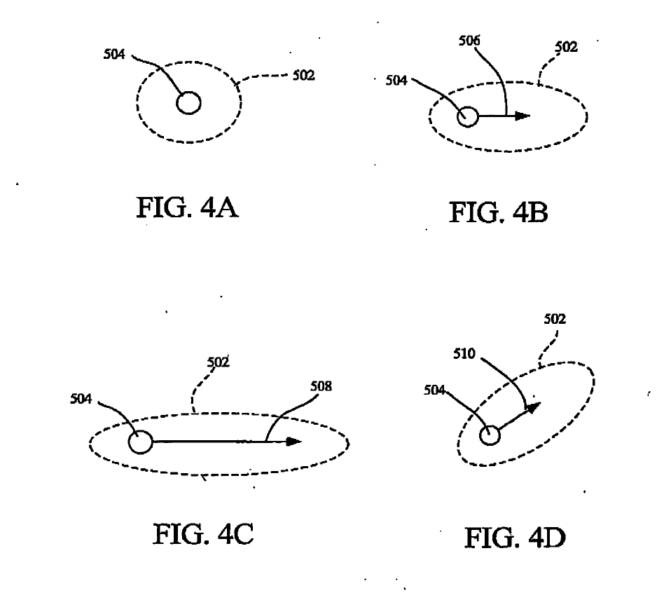

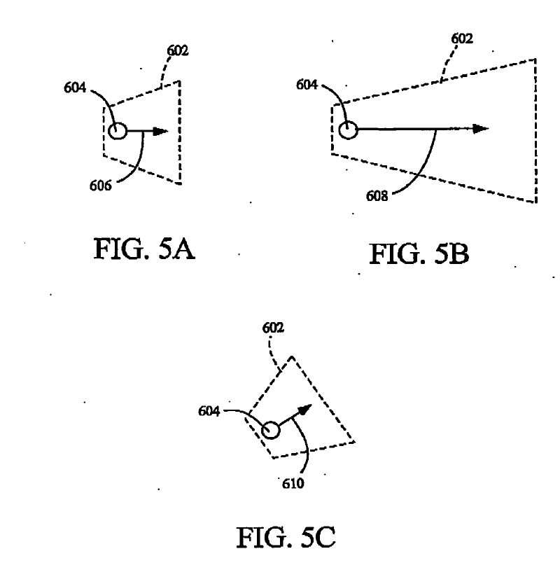

Methods of defining a proximity region around a user include methods by which the size and/or shape of the proximity region are dependent upon the speed and/or direction of motion of the user. In some embodiments, the size of the proximity region is dependent upon the speed at which the user is moving, e.g., the faster the user is moving the larger the proximity region. This method may be highly effective in that it accounts for the fact that a quickly moving user may need to be alerted to a piece of information he or she is nearing with more lead-time (i.e., advanced warning) than a slowly moving user. In some embodiments, the shape of the proximity region is dependent upon the direction at which the user is moving, e.g., extending (i.e. stretching) the proximity region outward in the direction towards which the user is then currently moving and shrinking (i.e. compressing) the proximity region inward in the directions away from which the user is currently moving. This method may be highly effective in that it accounts for the fact that a moving user is more likely to be interested in information that is ahead of him in his direction of travel and less likely to be interested in information that is behind him or his direction of travel. In some embodiments, the shape of the proximity region is further dependent upon the direction at which the user is moving, also adjusting the shape of the proximity region in the directions orthogonal to the direction of travel. In some of such embodiments, the shape of the proximity region in the direction orthogonal to the direction of user travel is compressed by an amount that is proportional to (or otherwise dependent upon the user's speed) such that the faster the user is moving the smaller the proximity region in the direction orthogonal to user motion. This method may be effective in that it accounts for the fact that a quickly moving user is less likely to be interested in the information that he or she is currently passing and more interested in the information that lies ahead in the direction of travel. Thus, according to the aforementioned embodiments, the proximity region may be extended (i.e., stretched) in the forward direction of travel by an amount that increases with increasing speed of the user and is shrunk (i.e., compressed) in the direction opposite to the direction of travel by an amount that increases within increasing speed of the user and furthermore is shrunk (i.e., compressed) in the directions orthogonal to the direction of travel) by an amount that increases within increasing speed of the user. In this way, the size and/or shape of the proximity region may dynamically change depending upon the speed of the user and/or the direction of travel of the user. The results of exemplary mathematical instantiations of such a model are exemplarily illustrated in FIGS. 4A-4D and FIGS. 4A-4C.

One mathematical instantiation of the model is an elliptical proximity region exemplarily described with respect to FIGS. 4A-4D. As generally shown in FIGS. 4A-4D, a generally circular (or slightly elliptical) proximity region 502 is defined around the user and becomes more distorted (e.g., elliptical) with the area of the ellipse extending with increasing distance forward in the direction of travel as the user increases his or her speed in a particular direction, and wherein the proximity region approximates a circle around the user with the user at the center as the user slows and approaches a zero speed.

For example, as shown in FIG. 4A, when a user 504 is either stationary or moving at relatively small speeds, the shape (i.e., a reference shape) of proximity region 502 defined around the user 504 approximates that of a circle of a particular size (i.e., a reference size).

As shown in FIG. 4B, when the user 504 increases his or her speed in a particular direction of travel (e.g., as indicated by arrow 506), the reference shape of the proximity region 502 as shown in FIG. 4A becomes distorted according to the speed and/or direction of motion of the user 504. As exemplarily illustrated, the reference shape of the proximity region 502 is distorted such that the proximity region is extended (i.e., stretched) in the forward direction of travel by an amount that corresponds with the user's speed of travel. The reference shape may also be shrunk (i.e., compressed) in the direction opposite to the particular direction of travel by an amount that corresponds with the user's speed of travel. The reference shape may also be shrunk (i.e., compressed) in the directions orthogonal to the particular direction of travel) by an amount that corresponds with the user's speed of travel. When the reference shape of the proximity region 502 is distorted as exemplarily described above, the distorted reference shape is aligned with the direction of travel. Because the amount by which the proximity region 502 is extended and shrunk is based, at least in part, upon the speed with which the user travels, both the size and the ultimate shape of the proximity is defined according to the user's speed and direction of travel.

As shown in FIG. 4C, when the user 504 further increases his or her speed in the particular direction of travel (e.g., as indicated by arrow 508), the shape of the proximity region 502 as shown in FIG. 4B becomes further distorted in correspondence with the user's speed of travel. As exemplarily illustrated, the reference shape of the proximity region 502 is distorted such that the proximity region is further extended (i.e., stretched) in the forward direction of travel by an amount that increases with the increased speed of the user 504. The reference shape may also be shrunk (i.e., compressed) in the direction opposite to the particular direction of travel by an amount that increases with the increased speed of the user 504. The reference shape may also be shrunk (i.e., compressed) in the directions orthogonal to the particular direction of travel) by an amount that increases with the increased speed of the user 504.

As shown in FIG. 4D, when the user changes his or her particular direction of travel from that shown in FIGS. 4B or 4C (e.g., as indicated by arrow 510), the shape of the proximity region 502 also changes such that the distorted reference shape maintains its alignment with the changed direction of travel.

Another mathematical instantiation of the model is a frusto-triangular (or conical) proximity region exemplarily described with respect to FIGS. 5A-5C. As generally shown in FIGS. 5A-5C, a frusto-triangular (or conical) proximity region is defined around a user, wherein the proximity region becomes more distorted with the area of the frusto-triangle extending with increasing distance forward in the direction of travel as the user increases his or her speed in a particular direction and becomes more contracted with the area of the frusto-triangle contracting with decreasing distance forward in the direction of travel as the user decreases his or her speed in a particular direction and/or approaches a zero speed.

For example, as shown in FIG. 5A, when a user 604 is either stationary and oriented along a particular direction indicated by 606 or moving at relatively small speeds along the particular direction indicated by 606, the shape (i.e., a reference shape) of proximity region 602 defined around the user 604 approximates that of a trapezoid or a frusto-triangle of a particular size (i.e., a reference size). In another embodiment, the shape of proximity region 602 as shown in FIG. 5A is a distorted reference shape and the user 604 is traveling along the particular direction at a particular speed.

As shown in FIG. 5B, when a user 604 is moving at a particular speed (or is increasing his speed of motion) in the particular direction (e.g., as indicated by arrow 608), the reference shape of the proximity region 602 becomes distorted according to the speed and/or direction of motion of the user 604. As exemplarily illustrated, the reference shape of proximity region 602 is distorted such that the proximity region is extended (i.e., stretched) in the forward direction of travel by an amount that corresponds with the user's speed of travel. The reference shape may also be shrunk (i.e., compressed) in the direction opposite to the particular direction of travel by an amount that corresponds to the user's speed of travel (e.g., behind the user along the direction of travel).

As shown in FIG. 5C, when the user 604 changes his or her particular orientation or direction of travel from that shown in FIG. 5A (e.g., as indicated by arrow 610), the shape of the proximity region 602 also changes such that it remains in alignment with the changed orientation/direction of travel.

Notwithstanding the discussion above, it will be appreciated that the proximity region may be of any desired shape and size. Moreover, it will be appreciated that the shape and size of the proximity region may be dynamically characterized in any desired manner by the speed of travel and/or the direction of travel of the user. It will also be appreciated that the proximity region may be defined with respect to, for example, an area or a volume.

According to numerous embodiments, a computer moderated system is disclosed which provides conditional alerts to users when they come within a certain physical proximity of a spatial location or spatial area that has information is associated with it. As disclosed herein, the certain proximity may be dependent upon the current direction of motion and/or speed of motion of the user. For example, the certain proximity may be the aforementioned proximity region around the user, the size and/or shape of the area being dependent upon the current direction of motion and/or current speed of motion of the user at that time. As disclosed herein, an “alert” refers to an imparted sensory cue provided to a user to inform the user as to the presence of a piece of spatially associated information that he or she is then currently near. The cue may be provided in a selectable form that further informs the users as to the type, importance, personal relevance, and/or proximity of the spatially associated information that he or she is then currently near. As used herein, a “conditional alert” means an alert that is also dependent upon some other factor. For example, a user may be conditionally alerted to the presence of a piece of spatially associated information if that piece of spatially associated information is linked to a location that falls within the current proximity region of the user and if that piece of information is also of an importance level that is above a certain threshold, is of an information type that the user has configured his preferences to trigger alerts for, and/or is a piece of information that use has access to by possessing a particular password or other means of authentication or authorization.

According to numerous embodiments, real-time sensory alerts may be provided to a user as he or she walks about a physical space, the real time alerts being provided to inform the user that he or she has come within a certain proximity of a piece of spatially associated information that meets certain conditionally criteria. In this way, user may be made aware of the presence of spatially associated information that is linked to certain locations within his or her current proximity, that information being of a certain personal relevance, type, and/or importance to the user, without that user needing to be constantly looking at a screen upon a portable computing device to find such information as he or she traverses the physical space. This frees up the user to devote visual and/or aural attention to the real physical space itself and not be distracted by a search for appropriate information.

Furthermore, real-time alerts may be provided through sensory modalities that are not visually or aurally intrusive or distracting to the user. For example, means may be provided to alert and/or conditionally alert a user to spatially associated information within his or her proximity through the use of tactile sensations that are imparted by haptic interface hardware and software technologies. For example, some embodiments may incorporate haptic hardware components and software technologies such as actuators and embedded control routines that enable tactile sensations to be selectively generated and imparted upon a user to alert the user when he or she has come within certain proximity of the spatial location or spatial area linked to certain spatially associated information. Thus, tactile sensation cues may be provided to a user as he or she wanders a physical space, alerting the user as to the presence of spatially associated information linked to a location that is within a certain proximity of that user's current physical location. Furthermore, the computer moderated system may be configured to select and imparts a specific tactile cue from among a plurality of different and perceptually distinguishable tactile cues upon the user, the selected tactile cue being imparted as a means of informing the user as to the type, importance, relevance, and/or proximity of spatially associated information that is linked to locations and/or areas that are within a certain proximity of that user's then current physical location. Furthermore, tactile cues of a selectable magnitude and/or frequency, the selected magnitude and/or frequency may be provided to inform the user as to the level of relevance and/or level of importance and/or closeness of proximity of spatially associated information that is linked to locations that are within a certain proximity of that user's then current physical location. In addition, a tactile alert may be conditionally imparted upon a user when that user comes within certain proximity of the location and/or area linked to a piece of spatially associated information, but only if that user is moving in a certain direction, moving below a certain speed, and/or is facing a certain direction. In this way, tactile alerts may be imparted dependent upon both the proximity of the user to spatially associated information and a direction of motion, a speed of motion, and/or a facing direction.

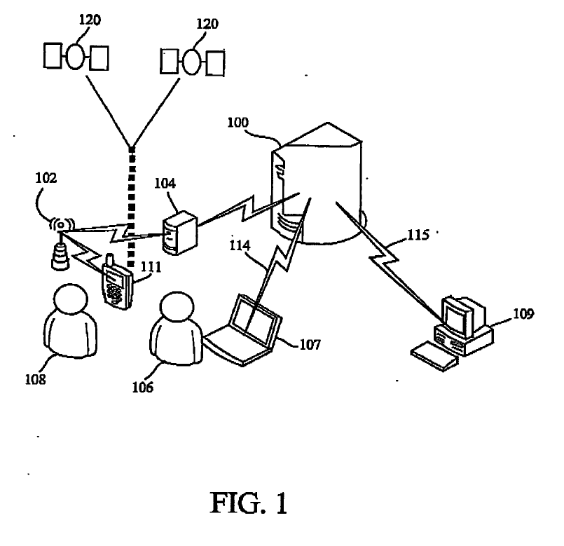

Referring to FIG. 1, a schematic diagram is provided of one embodiment of a personal cuing system adapted to implement the functions exemplarily described above. The schematic diagram shows a spatial information alerting system that enables users of portable computing devices (for example user 106 and user 108) to receive alerts and/or conditional alerts when they come within a certain proximity of a spatial location and/or spatial area for which certain spatially associated information is linked. As represented in FIG. 1, one embodiment of a cuing system is comprised of a spatially associated information (SAI) server or a group of servers that contains circuitry adapted to support the spatial association between information and physical locations and/or areas. As used herein, the term “circuitry” refers to any type of executable instructions that can be implemented, for example, as hardware, firmware, and/or software, which are all within the scope of the various teachings described. This server or group of servers is referred to herein simply as the SAI server 100 (100). The circuitry contained within the SAI server 100 is operative to associate spatial locations and/or spatial areas with pieces of digital information (i.e., information files). An information file may include text, images, numerical data, videos, sounds, music, web pages, URL locations, and/or any other common forms of digitally stored information or media.

In one embodiment, circuitry contained within the SAI server 100 maintains and/or accesses a database of spatial locations and/or spatial areas, each spatial location and/or spatial area being linked to one or more pieces of information. Such a database is referred to herein as a SAI database. The SAI database may be maintained on a single computer or a plurality of computers. In general, a single spatial location and/or spatial area may be associated with a plurality of distinct pieces of information (i.e., information files) within the SAI database. Each information file referenced in the SAI database may also be associated with particular user mobility conditions that must be satisfied in order for a user to be alerted to the information and/or in order for the user to access the information. For example, an information file referenced in the SAI database may also be associated with a particular direction that a user must be facing and/or moving to be alerted to that information file. The direction may be specified a range of values thereby expressing a range of acceptable directions that the user must be facing and/or moving to be alerted to the associated information file. Each information file referenced in the SAI database may also be associated with a particular distance of influence or area of influence, for example, a distance within which or an area within which a user must be located to be alerted to that information file. In this way, an information file that refers to something large like a tall building may trigger an alert to users who are a large distance away while an information file that refers to something small, like a flower may trigger an alert only for users who come within a very small distance or area of its location. Each information file referenced in the SAI database may also be associated with a particular speed of motion, for example a speed below which a user must be moving to be alerted to that piece of information. In this way, an information file that refers to something large like a tall building may trigger an alert for a quickly moving user while an information file that refers to something small, like a flower may only trigger alerts for users who pass by below a certain speed. Furthermore, a single information file within the SAI database may be associated with a plurality of the user mobility conditions mentioned above. For example, a single information file may be associated with a particular direction of motion, a particular influence distance, and a particular speed of motion such that a user must be moving in a particular direction of motion, must be within a certain influence distance of the location that the information file is associated with, and must be moving below a particular speed, for that user to be alerted to and/or granted access to the particular information file.

Each information file referenced in the SAI database may also be associated in the database with temporal conditions which indicate a particular time or times when a user may be alerted to and/or gain access to a particular piece of information. For example, an information file referenced within the SAI database may be associated with particular times-of-day when that information may trigger alerts to users. For example, an information file that is associated with a particular store may be configured to trigger alerts only during business hours. Similarly, an information file referenced within the SAI database may be associated with particular days-of-the-week when that information may trigger alerts to users. For example, information files that are associated with a particular street event that only happens on weekends may be configured to trigger alerts only on the weekend days-of-the-week. Furthermore, a single information file within the SAI database may be associated with a plurality of the temporal conditions mentioned above. For example, a single information file may be associated with particular times-of-day and particular days-of-the-week for which users may be alerted to and/or granted access to the particular information file. In addition, the temporal conditions mentioned above may include an expiration date for a piece of spatially associated information which is a date beyond which the information file will not trigger an alert and/or be accessible to users.

Each information file referenced in the SAI database may also be associated in the database with weather conditions which indicate a particular weather condition when a user may be alerted to and/or gain access to a particular piece of information. For example, an information file referenced within the SAI database may be associated with particular temperature ranges when that information may trigger alerts to users. For example, an information file that is associated with heat stroke warnings may be configured to trigger alerts only when the outdoor temperature is above 90 degrees Fahrenheit. Similarly, an information file referenced within the SAI database may be associated with particular cloud conditions and/or precipitation conditions when that information may trigger alerts to users. For example, an information file is associated with a particular street event that does not happen when it is raining or snowing, may be configured to trigger alerts only at times when the current weather conditions in that particular location (as accessed from a web based weather server) do not indicate that it is raining or snowing Furthermore, a single information file within the SAI database may be associated with a plurality of the weather conditions. For example, a single information file may be associated with particular temperature range and particular cloud conditions for which users may be alerted to and/or granted access to the particular information file.

Each information file referenced in the SAI database may also be associated in the database with descriptive tags or other similar identifiers which indicate, for example, a type or classification or other categorization of the information, an importance level of the information. In this way, an information file may be associated with a type such as terrain thereby indicating that the information refers to the terrain at the location for which it is associated. Other types may include, for example, historical, scientific, commercial, social, entertainment, educational, and safety. Furthermore, each type may have subtypes associated with it. For example, educational information may be further classified into grade levels or grade ranges. For example, certain information may be educational and may be appropriate for and/or intended for users who are in first and second grade. Such information may therefore be associated with a descriptive tag that identifies it as educational and further identifies it as intended for first and second grades. Other information may be appropriate for and/or intended for users who are in high school. Such information may therefore be associated with a descriptive tag that identifies it as educational and further identifies it as intended for high school grade levels. Thus, when used with the other methods and systems described herein, the features described hereinabove enable a very powerful system in which a user can specify which type of information they desire to be alerted to and thereby receive alerts to that type of information when they come within a certain proximity of it. In this way, a first grade student can, for example, wander a park and receive spatially associated information about various aspects of the part, that information being specifically tagged as educational and intended for first and second graders. Furthermore, a high school student may wander the very same physical space and using the methods and systems described herein be alerted to different information that is linked to the same or similar spots, the high school student being alerted to educational information that is appropriate for and/or intended for high school students. In this way, a plurality of users can wander the same space and be alerted only that information is relevant to them. This may be particularly useful for the educational applications disclosed herein wherein particular users are alerted to spatially associated information as they wander a physical space that is intended for the age and/or grade level of that user.

Each information file referenced in the SAI database may also be associated in the database with user demographic conditions which indicate a particular demographic characteristic of users who are to be alerted to and/or gain access to a particular information file. For example, an information file referenced within the SAI database may be associated with a particular demographic characteristic such as gender such that only users who identify themselves through personalized user settings as belonging to that gender will be alerted to and/or granted access to that piece of spatially associated information when coming within a certain proximity of it. Similarly, an information file referenced within the SAI database may be associated with a particular demographic characteristic such as age range such that only users who identify themselves through personalized user settings as falling within a certain age range will be alerted to and/or granted access to that piece of spatially associated information when coming within a certain proximity of it. Similarly, an information file referenced within the SAI database may be associated with a particular demographic characteristic such as personal hobby or interest such that only users who identify themselves through personalized user settings as having that personal hobby or interest will be alerted to and/or granted access to that piece of spatially associated information when coming within a certain proximity of it. Similarly, an information file referenced within the SAI database may be associated with a particular demographic characteristic such as income level such that only users who identify themselves through personalized user settings as having that income level will be alerted to and/or granted access to that piece of spatially associated information when coming within a certain proximity of it. Similarly, an information file referenced within the SAI database may be associated with a particular demographic characteristic such as job title, highest level of education, and/or profession type such that only users who identify themselves through personalized user settings as having that job title, highest level of education, and/or profession type will be alerted to and/or granted access to that piece of spatially associated information when coming within a certain proximity of it. Similarly, an information file referenced within the SAI database may be associated with a particular demographic characteristic such as marital status and/or sexual orientation such that only users who identify themselves through personalized user settings as having that marital status and/or sexual orientation will be alerted to and/or granted access to that piece of spatially associated information when coming within a certain proximity of it. Similarly, an information file referenced within the SAI database may be associated with a particular demographic characteristic such as political party affiliation such that only users who identify themselves through personalized user settings as associating themselves with that particular political party be alerted to and/or granted access to that piece of spatially associated information when coming within a certain proximity of it.

Each information file referenced in the SAI database may also be associated in the database with user specific conditions which indicate a particular user, group of users, and/or organizational memberships of users who are to be alerted to and/or gain access to a particular information file. For example, an information file referenced within the SAI database may be associated with a particular user or group of users such that only that only specifically identified users(s) will be alerted to and/or granted access to that piece of spatially associated information when coming within a certain proximity of it. Similarly, an information file referenced within the SAI database may be associated with a particular required password or authentication to be alerted to and/or gain access to the information. Similarly, an information file referenced within the SAI database may be associated with a particular organization or group such that only that only documented members of that group or organization will be alerted to and/or granted access to that piece of spatially associated information when coming within a certain proximity of it. For example, certain pieces of spatially associated information may be associated with membership in a certain historical society such that only members of that historical society may be alerted to and/or granted access to that information when coming within a certain proximity of it. In this way, members of that historical society will have a unique and enhanced experience when wandering a particular physical place as compared to other people who are wandering that same place. As another example, certain pieces of spatially associated information may be associated with enrollment in a particular school and/or alumni status with a particular school such that only students and/or alumni of that particular school may be alerted to and/or granted access to that information when coming within certain proximity of it. In this way, students and/or alumni of a particular school will have a unique and enhanced experience when wandering a particular physical place as compared to other people who are wandering that same place.

In some embodiments, users may leave spatially associated information at a particular location (i.e. create it and link it to that location), for example virtual notes. When a user leaves information using the methods and systems described herein, they may specify the user mobility conditions, user demographic conditions, weather conditions, temporal conditions, descriptive tags, and/or user specific conditions for which users may be alerted to and/or granted access to the spatially associated information. For example, an alumni to a particular university, for example Stanford University, might wander a particular place such as San Francisco, and leave comments and/or insights and/or observations as textual notes or other forms of information media linked to specific locations around the city. That user may designate the information he leaves as having a user specific condition such that only other alumni of Stanford University will be alerted to and/or granted access to the information when they come within certain proximity of the information. In this way, a plurality of alumni to Stanford University may wander the city and have a unique experience of sharing spatially associated information (i.e., linked virtual notes that include comments and observations and insights) that have been left by and are accessible only by other alumni to the University. This allows Stanford Alumni to have a spatial experience within San Francisco that would be unique and distant from other groups, for example Berkeley Alumni, who might be leaving notes and linking their spatially associated information to user specific conditions such that only other alumni of Berkeley will be alerted to and/or granted access to the information when they come within a certain proximity of the information. Thus, Stanford and Berkeley alumni can wander the same space and have very different and customized interactions with spatially associated information. To prevent Berkeley Alumni from leaving offensive notes and linking those notes to a user specific condition such that it is intended for alumni of their rival Stanford, an optional for a password feature and/or other authorization feature may be provided that prevents a user from linking a piece of information with some user specific conditions unless they are in possession of the password or are otherwise authorized or authenticated as a member of the group for which they are leaving information.

Referring back to FIG. 1, the system also includes one or more portable computing devices (for example laptop 107 and cell phone 111) configured to communicate with the SAI server 100 and thereby provide alerts and/or conditional alerts when a user comes within a certain proximity (e.g., as defined by the aforementioned proximity region) of certain spatially associated information. In general, the portable computing device may contain client application circuitry adapted to moderate the communication with the SAI server 100 and enable the portable computing device to generate and impart the appropriate alerts upon the user at the appropriate times based upon the then current location of the user as well as optional other spatial factors such that the current direction the user is facing or positioning the portable computing device, the current direction the user is moving, and/or the current speed at which the user is moving. Such client application circuitry is referred to herein as the SAI client application circuitry and is generally supported by one or more processors local to the portable computing device.

To perform the spatial functions described herein, the portable computing device 111 contains, or is connected to, one or more locative sensors. The SAI client application circuitry is operative to access data from the one or more locative sensors to determine a current position of the user various points in time. The SAI client application circuitry may also be operative to store a time history of locative sensor data to determine a current speed of motion, direction of motion, and/or trajectory of motion of the user at various points in time. In many embodiments, the locative sensors include one or more GPS transducers that derive current spatial location information for the portable computing device by receiving data from orbiting satellites 120. The GPS transducer is operative to provide latitude, longitude, and altitude coordinates to the SAI client application circuitry. The locative sensors may also include other sensors such as a directional sensor such as a magnetometer and/or accelerometer that provides directional data. In general, the SAI client application circuitry accesses the locative sensor data at a rapid and regular interval such that it has access to substantially current locative information for the user in possession of the portable computing device. The current locative information generally includes spatial coordinates (such as latitude and longitude) identifying the geographic position of the user's portable computing device (and thus the user). The current locative information may also include altitude, orientation, speed, and direction of motion information.

As also shown in FIG. 1, the portable computing devices described herein include a communication link, generally a wireless communication link, to a network such as the Internet and/or cellular network that enable the portable computing device to exchange data with the SAI server 100. The methods and systems described herein may be implemented as a managed service (e.g., in an ASP model) using a SAI server 100, which is connected or connectable to one or more networks. In a general embodiment, the service may be provided by an operator using a set of one or more computing-related entities (e.g., systems, machines, processes, programs, libraries, functions, or the like, or combinations thereof) that together facilitate or provide the functionality described herein. In one implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a corporate intranet, a private network, or any combination thereof, depending on the desired implementation environment. As illustrated FIG. 1, the SAI server 100 is also in communication with a mobile service provider (MSP) 102 through a gateway, such as SMS gateway 104.

As also illustrated in FIG. 1, one or more users 106 may register for the service, typically by using a client machine which may be the portable computing device 111 or some other machine such as a personal computer 107. When a personal computer 107 is used, registration is initiated by an end user opening a Web browser to the operator's Web site registration page (or set of registration pages). When a portable computing device 111 is used, registration may be initiating through a mini-browser or other similar interface. These techniques are merely representative, as any convenient technique (including, without limitation, email, filling out and mailing forms, and the like) may be used. Thus, in the illustrated embodiment, users register with the SAI server 100 (or set of servers) either through Internet connections from personal computers, or via remote registration through a mobile device. The registration process may include the setting user preferences about the type, classification, and/or other conditional aspects of being alerted to spatially associated information as they user comes within proximity of such information. For example the registration process may collect demographic information about the user such that user demographic tags may be considered when alerting that particular user to particular spatially associated information. The registration process may also connect organizational affiliations and/or membership information and/or user ID information and/or user password information such that user specific conditions may be considered when alerting that particular user to particular spatially associated information.

Also illustrated in FIG. 1 is a Global Positioning System (GPS) 120 that may be used in some embodiments for tracking the location of portable computing devices such as device 111. Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed. However, other positioning systems are also contemplated for use with the embodiments exemplarily described herein. For GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

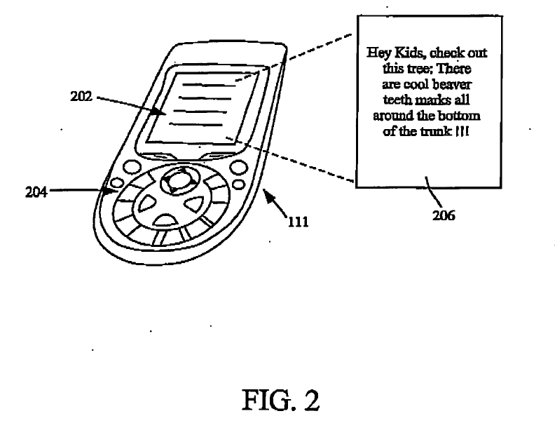

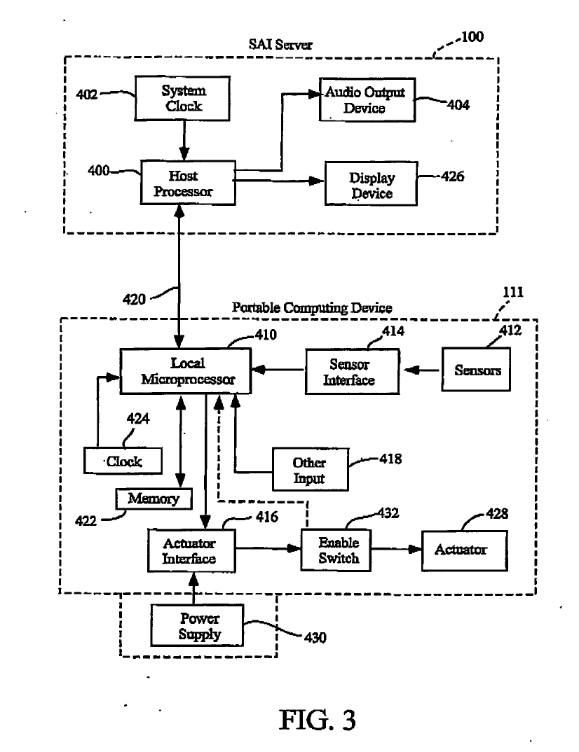

FIG. 2 illustrates a portable computing device 111 is exemplarily configured with appropriate client application circuitry to support the functionalities disclosed herein. As shown in FIG. 2, the portable computing device 111 may take the form of a handheld device such as a cell phone or PDA and includes display functionality and user interface controls. Such a portable computing device 111 supports SAI client application circuitry and is thereby operative to exchange information with the SAI server 100 over a communication link. The communication link may take any common form (e.g., a wireless communication link to an information network such as the Internet). The portable computing device may also include a differential GPS transceiver for sensing the geographic position of the portable computing device with a high degree of accuracy. The GPS transceiver or other locative sensor is used with respect to certain embodiments, as will be described in more detail herein. The portable computing device includes a user interface including display features 202 and user input features 204. In many embodiments, a graphical user interface is enabled upon the display that allows users to enter information and/or make selections to configure and/or direct the SAI client application circuitry. In addition, the display features 202 of the portable computing device 111 may also be used to present visual contents of spatially associated information that may be accessed by the user. In this case, the display 202 shows a virtual note left in a local park by a kid who goes to Washington Elementary School for other kids who go to the same school. The note is a piece of spatially associated information that is linked to the location of a particular tree within the local park. As shown, element 206 is an enlargement of a sample display of the note as would be shown upon the portable computing device 111.

Portable computing device 111 is also equipped with one more haptic actuators and haptic control electronics/software for selectively generating one or more haptic sensations upon the user to alert the user as to the presence of spatially associated information within his or her proximity. An example of haptic actuators and haptic control electronics for delivering haptic sensations to a user is disclosed in issued U.S. Pat. No. 6,211,861, which was co-invented by Rosenberg (the same inventor as this current disclosure) and is hereby incorporated by reference. The actuators may take a variety of forms, for example the actuators generate and impart haptic sensations by moving an inertial mass under electronic control, the inertial mass being moved by the actuator to create rapidly changing forces that can be felt by the user as a distinct and informative haptic sensation that alert the user. Such haptic sensation alerts may be conditional upon many other factors as described throughout this disclosure. The SAI client application circuitry, in combination with the SAI server 100, may determine if an alert should be generated and selectively activate the haptic hardware and software upon the portable computing device to impart an appropriate tactile sensation upon the user when an alert is required. This allows the user to keep the portable computing device in his pocket, on his belt, worn on his wrist, or otherwise proximal to his body without needing to continually look at the screen to find spatially associated information that he or she may wander past. For example, a kid may be playing within the local park mentioned in the previous example and when that kid comes within a certain proximity of the mentioned tree location, the haptic hardware is triggered and imparts a particular haptic sensation upon the child. In some embodiments, the alert may be conditionally applied, for example only alerting the user if he or she is a student at Washington Elementary School as defined by user specific conditions linked to the particular piece of spatially associated information. The child may have been walking past, running, or otherwise playing and not paying attention to his or her portable computing device. The tactile alert unobtrusively alerts the child to the presence of information within his or her vicinity that is relevant to him or her. The child, upon feeling the tactile sensation, may pull the portable computing device from his pocket or otherwise bring it into visual range. The child may then access the piece of spatially associated information—in this case the visually displayed note as shown in FIG. 2 at 206. As will be described in greater detail below, the tactile sensation that is imparted upon the user may be selected from a plurality of available tactile sensations and/or may be configured with a particular form such that the unique tactile characteristics of the sensation provide the user with information as to the type, importance, proximity, and/or relevance of the information. In this way, the user can gain some information about the characteristics of the spatially associated information by just feeling the tactile alert and without needing to visually or aurally access information from the portable computing device.

With respect to the haptic actuators, one or more haptic actuators are incorporated upon or within the portable computing device such that when activated the user feels a tactile sensation. There are many such actuators known the art and many methods by which haptic actuators may be controlled to impart haptic sensations known to the art. Example actuators are disclosed in U.S. Pat. No. 6,221,861, which is incorporated herein by reference. Such actuators may be incorporated into the portable computing device (or a peripheral thereof) such that when energized, the user will feel a haptic sensation as a result of changing forces imparted by the actuator. In some embodiments, the actuators impart forces as inertially induced vibrations that are transmitted to the user through the housing of the portable computing device. The user who is holding the housing of the portable computing device will feel the forces as haptic sensations.

In other embodiments, different types of actuators can be used. For example, a solenoid having a vertically-moving portion can be used for the linear actuator. A linear voice magnet, DC current controlled linear motor, a linear stepper motor controlled with pulse width modulation of an applied voltage, a pneumatic/hydraulic actuator, a torquer (motor with limited angular range), a piezo-electric actuator, etc., can be used. A rotary actuator can be used to output a torque in a rotary degree of freedom on a shaft, which is converted to linear force and motion through a transmission, as is well known to those skilled in the art.

FIG. 4 is a block diagram illustrating one embodiment of the haptic feedback enabled portable computing device of embodiments described herein. Also shown is the SAI server 100 which may be a single computer or a plurality of computers (it is shown as a single computer in this figure). Portable computing device 111 is coupled to SAI server 100 by a bidirectional wireless communication link 420. The bidirectional wireless communication link sends signals in either direction between server 100 and the portable computing device 111. Portable computing device 111 includes a microprocessor 410 that runs software for interacting with the SAI server 100 and for controlling the haptic actuator (or actuators) to produce appropriate haptic sensations. Microprocessor 410 is also operative to read data from sensors 412 which includes at least one locative sensor that tracks the current spatial location of the portable computing device. In common embodiments the locative sensor is a GPS transducer as described previously. Other sensors may include magnetometer orientation sensor and/or accelerometer pitch sensors and/or temperature sensors for outdoor temperature. Suitable microprocessors for use as local microprocessor 410 include the MC68HC711E9 by Motorola, the PIC15C74 by Microchip, and the 82930AX by Intel Corp. Microprocessor 410 can include one microprocessor chip, multiple processors and/or co-processor chips, and/or digital signal processor (DSP) capability.

Microprocessor 410 provide signals to actuator 428 causing the actuators to produce haptic sensations upon the user in accordance with the determined alerts. The alerts may be determined by circuitry supported by the portable computing device, by circuitry supported by the SAI server 100, or by a combination of operations performed on both platforms. For example, in one embodiments, (as will be discussed in more detail to follow), the SAI server 100 receives locative data from the portable computing device over link 420 and derives based upon the locative data and the information stored in the SAI database (as described previously) whether or not a tactile alert should be imparted upon the user at the current time. If a tactile alert is to be imparted upon the user at the current time, the SAI server 100 determines the type and form of the haptic sensation and sends a high level supervisory haptic commands to the portable computing device over link 420. Microprocessor 410 decodes the commands and control actuators in accordance with the high level commands from the SAI server 100, thereby producing the required sensations. Such transmission of high level supervisory haptic commands from one computing device to another is described in greater detail in U.S. Pat. Nos. 5,739,811 and 5,734,373, both incorporated by reference herein. Under such a paradigm, the local microprocessor 410 reports locative data to the SAI server 100 describing the position of the portable computing device in physical space as well as optionally describing the direction of motion, speed of motion, and/or orientation of the portable computing device within the real physical environment. Based upon the locative data received from portable computing device the SAI server 100 determines if the user is within a certain proximity of any spatially associated information by cross referencing locations within the SAI database. The SAI server 100 also considers other factors that may determine if the user is to be alerted to any near by spatially associated information such as the user mobility conditions, temporal conditions, user demographic conditions, user specific conditions, descriptive tags, and/or weather conditions that may be associated with information within the user's proximity. Depending upon the conditions considered, additional information may be sent to the SAI server 100 and/or accessed by the SAI server 100. For example, the SAI server 100 may access weather data for the particular location of the user by accessing a weather data website and indexing current weather data by GPS location. Also for example, if user demographic conditions are considered and/or user specific conditions are considered, the SAI server 100 requires access to demographic information about the user and/or identity information about the user and/or group membership information about the user. Such information may be sent from the portable computing device to the SAI information as required or such information may be stored upon the SAI server 100 in a user information database that is indexed by a unique ID or other identifier for each user. The information stored in such a database may be entered by the user upon a registration process with the service. An example of how such a database might function is disclosed in detail in co-pending patent application Ser. No. 11/383,197, entitled LOCATION-BASED DEMOGRAPHIC PROFILING SYSTEM AND METHOD OF USE, filed on May 12, 2006, and hereby incorporated by reference.

Based upon all relevant factors, the SAI server 100 determines if an alert is to be triggered for the user—if so, a message is sent from the SAI server 100 to the portable computing device indicating that an alert is required for a particular piece or pieces of spatially associated information. The message, in some embodiments, includes descriptive information as to the type, importance, relevance, and/or proximity of the spatially associated information (i.e., the information file) that the user is to be alerted to. Based upon the received message and optionally based upon the indication of type, importance, relevance, and/or proximity of the spatially associated information, the local processor on the portable computing device selects and imparts a tactile sensation to alert the user. In some embodiments, a specific tactile cue sensation is selected from among a plurality of different and perceptually distinguishable tactile cues based upon the indicated type, importance, relevance, and/or proximity of the selected tactile cue informing the user as to the type of spatially associated information that is linked to locations that are within a certain proximity of that user's then current physical location. In some situations, there may be a plurality of distinct pieces of spatially associated information that are located at the same or similar location and which all are determined to trigger alerts. In such cases, a set of tactile cues, one for each piece of spatially associated information, may be imparted upon the user in sequence. Alternatively, only one tactile cue is imparted for the plurality of distinct pieces of spatially associated information. In some embodiments, the one tactile cue that is imparted is presented with a profile that indicates, for example by a certain number of distinguishable pulses and/or by a certain magnitude and/or by a certain frequency, the absolute or relative number of distinct pieces of spatially associated information that are associated with the tactile alert. In this way, a single tactile alert can inform the user as to the presence of spatially associated information in his or her proximity and the quantity of distinct pieces of spatially associated information in his or her proximity. Furthermore, some embodiments, provides tactile cues of a selectable magnitude and/or frequency, the selected magnitude and/or frequency being provided to inform the user as to the importance of spatially associated information that is linked to locations that are within a certain proximity of that user's then current physical location. Furthermore, in some embodiments, tactile cues of a selectable magnitude and/or frequency are provided, wherein the selected magnitude and/or frequency are provided to inform the user as to the proximity of spatially associated information that is linked to locations that are near that user's then current physical location.

In the above paragraphs, the determination as to whether or not an alert is to be triggered is made by the SAI server 100 based upon information received from the portable computing device, the information including current locative information for the portable computing device as collected by locative sensors on board and/or connected to the portable computing device. Such embodiments are referred to herein as “SAI server 100 determining embodiments.” Another set of embodiments (i.e., “portable computing device determining embodiments”) may also implement the functionalities described above. The portable computing device determining embodiments implement a different distribution of labor between the portable computing device and the SAI server 100 than the SAI server 100 determining embodiments. In the portable computing device determining embodiments, the determination as to whether or not alerts are to be imparted upon the user and the selection of the specific sensory content to be included in the alert are made by circuitry supported by the portable computing device. These embodiments generally function by the portable computing device downloading portions of the SAI database from the SAI server 100 for the local areas in which the user is currently traversing. For example, if a user is in a county park, the portable computing device accesses the SAI server 100 and downloads a portion of the SAI database relating to the county party extending for a certain area around the user. In this way, the portable computing device has access to the linkages between spatially associated information in the user's current vicinity and specific locations and/or areas in the user's current vicinity. The portable computing device also has access to other factors stored in the database such as the user mobility conditions, temporal conditions, user demographic conditions, user specific conditions, descriptive tags, and/or weather conditions that may be associated with information within the user's proximity. Using such information, the routines running upon the portable computing device may determine based upon the user's current spatial location and optionally based upon the user's current direction of motion, speed of motion, and/or orientation of the portable computing device within the real physical environment, whether or not any alerts are to be triggered at the current time. In some embodiments, a specific tactile cue sensation is selected by the routines running upon the portable computing device from among a plurality of different and perceptually distinguishable tactile cues based upon the indicated type, importance, relevance, and/or proximity of the selected tactile cue informing the user as to the type of spatially associated information that is linked to locations that are within a certain proximity of that user's then current physical location. In some situations, there may be a plurality of distinct pieces of spatially associated information that are located at the same or similar location and which all are determined to trigger alerts. In such cases, a set of tactile cues, one for each piece of spatially associated information, may be imparted upon the user in sequence by the portable computing device. Alternatively, one tactile cue is imparted for the plurality of distinct pieces of spatially associated information. In one embodiment, a combination of SAI server 100 determined and portable computing device determined embodiments may be employed together.

As used herein, the term “tactile sensation” refers to either a force or sequence of forces output by the actuator 428 which provide a physically perceivable sensation to the user. For example, a vibration, a jolt, a series of jolts, and a texture may all be considered tactile sensations. Referring back to FIG. 4, local memory 422, such as RAM and/or ROM, is preferably coupled to microprocessor 410 in portable computing device 111 to store instructions for microprocessor 410 and store temporary and other data. For example, force profiles can be stored in memory 422, such as a sequence of stored force values that can be output by the microprocessor to the actuator, or a look-up table of force values to be output to the actuator based on whether or not the portable computing device is successfully pointing at and/or is successfully within a certain proximity of a particular electronic appliance. In addition, a local clock 424 can be coupled to the microprocessor 410 to provide timing data, similar to system clock 402 of SAI server 100; the timing data might be required, for example, to compute forces output by actuator 428.

Also, the local memory 422 can store predetermined force sensations to be sent by the microprocessor to the actuator (or actuators) aboard the portable computing device that are to be associated with particular types, importance levels, relevance levels, and/or proximity distances of spatially associated information. Alternatively, the SAI server 100 can directly send force feedback signals by wireless link to the portable computing device 111, the signals used by the microprocessor to generate the specific tactile sensations on the actuator. Actuator 428 transmits forces to the housing of the portable computing device in response to signals received from microprocessor 410 and/or SAI server 100. In some embodiments, actuator 428 is provided to generate inertial forces by moving an inertial mass. The actuator described herein has the ability to apply short duration force sensations on the casing (i.e., housing) of the portable computing device. In other embodiments, a “periodic force sensation” can be applied to the user through the handheld unit, where the periodic sensation can have a magnitude and a frequency, e.g. a sine wave; the periodic sensation can be selectable among a sine wave, square wave, saw-toothed-up wave, saw-toothed-down, and triangle wave; an envelope can be applied to the period signal, allowing for variation in magnitude over time; and the resulting force signal can be “impulse wave shaped” as described in U.S. Pat. No. 5,959,613 which is hereby incorporated by reference.

Actuator interface 416 can be optionally connected between actuator 428 and microprocessor 410 to convert signals from microprocessor 410 into signals appropriate to drive actuator 428. The interface 16 may include power amplifiers, switches, digital to analog controllers (DACs), analog to digital controllers (ADCs), and other components, as is well known to those skilled in the art. Other input devices 418 may be included within portable computing device 111 and send input signals to microprocessor 410 or to SAI server 100 when manipulated by the user. Such input devices include buttons 418 and can include additional buttons, dials, switches, scroll wheels, or other controls or mechanisms. In some embodiments, such input devices are used by the user to adjust the proximity range and/or proximity region within which spatially associated information triggers alerts. In this way, the user can manually adjust the size of the area for which alerts and/or conditional alerts are determined and imparted upon the user. In one embodiment, a scroll wheel is provided to the user upon the portable computing device, the scroll wheel and controlling circuitry configured such that the user's manipulation of the wheel increases and/or decreases the range and/or size of the proximity region being considered by the circuitry for alerts and/or conditional alerts. This provides the user with a “local scanning capability” in which the user can expand the proximity region around himself or herself until an alert is felt. In some embodiments, a visual indication of proximity distance and/or size is displayed upon the screen of the portable computing device as they user adjusts the scroll wheel, indicating to the user in real-time the distance and/or size of the proximity region as he or she performs such a local scanning operation. This active user method is generally implemented as a feature that functions along with the more passive user methods described herein giving the user various options in how he or she finds desired spatially associated information.

Power supply 430 (e.g., one or more batteries), is included in portable computing device 111 and is coupled to actuator interface 416 and/or actuator 428 to provide electrical power to the actuator. Enable switch 432 can optionally be included to allow a user to deactivate actuator 428 for power consumption reasons, for example if batteries are running low.

As mentioned herein, a variety of different tactile (haptic) sensations can be imparted upon the user by the actuator (or actuators) as controlled by the microprocessor on board the portable computing device. While a wide range of sensations are possible, a number of samples are provided here as a means of example:

Basic Alert Sensation—software running upon the microprocessor 410 of the portable computing device 111 can be configured to control the actuator (or actuators) to impart a sensation upon the user when it is determined that spatially associated information is within a certain proximity of the user as the user wanders a real physical space. The sensation, for example, may be a short duration vibration of moderate magnitude that informs the user of the presence of information within his or her proximity. The sensation itself may be constructed as a sinusoidal varying force applied for 2000 milliseconds and a frequency of 35 HZ. The sensation will feel to the user as a vibration and may also be impulse wave shaped such that an initial impulse accentuates the onset of the sensation for increased perceptual impact.

Direction and/or Motion Specific Alerts Sensations: software running upon the microprocessor 410 of the portable computing device 111 can be configured to control the actuator (or actuators) to impart a sensation upon the user when it is determined that spatially associated information is within a certain proximity of the user as the user wanders a real physical space and that the user is moving in a direction, moving at a speed, and/or holding the portable computing device (or a portion thereof) in an orientation that meets one or more user mobility conditions associated with that piece of spatially associated information. The determination is made in part upon a computed match between one or more required user mobility conditions associated with a particular piece of information in proximity of the user and an analysis of the motion data derived from the sensors on board the portable computing device. For example, to determine whether or not the direction of motion of the user at the current time matches a required direction of motion of a user mobility condition and/or falls within a range of direction of motions of a user mobility condition, a direction of motion is computed for the user by taking a current position data coordinate of the user and a recent previous position data coordinate for the user, subtracting them, and through basic vector math techniques determining a motion vector for the user. The magnitude of the motion vector represents the current speed of the user. The direction of the motion vector represents the current direction of motion of the user. Thus, the direction of the motion vector is used to determine if the direction of motion of the user at the current time matches a required direction of motion of a user mobility condition and/or falls within a range of direction of motions of a user mobility condition. This magnitude of the motion vector can be used to determine if the speed of motion of the user at the current time is above or below a required threshold speed of motion of a user mobility condition. To determine if the user is holding the portable computing device (or a portion thereof) in a particular orientation, data from additional orientation sensors are generally accessed and compared to the required orientation values or ranges. For example, magnetometer data and/or accelerometer data may be accessed (if included within the portable computing device) and used for this purpose. For example, if a piece of spatially associated information is associated with a computing device orientation of South-West, magnetometer data will be accessed to determine if the portable computing device is being held within a certain range of the required South-West direction. If so (and assuming all other required conditions are already met), an alert will be selected and imparted upon the user. Assuming the required user mobility condition or conditions are met, the alert sensation is selected and imparted upon the user. The sensation may, for example, be a short duration vibration of moderate magnitude that informs the user of the presence of information. The sensation itself may be constructed as a sinusoidal varying force applied for 2500 milliseconds and a frequency of 50 HZ. The sensation will feel to the user as a vibration and may also be impulse wave shaped such that an initial impulse accentuates the onset of the sensation for increased perceptual impact.

Relevance Alert Sensation—software running upon the microprocessor 410 of the portable computing device 111 can be configured to control the actuator (or actuators) to impart a unique sensation that is perceptually different from other sensations imparted by the system when it is determined that spatially associated information is within a certain proximity of the user as the user wanders a real physical space and that the information is of high relevance to the particular user of the portable computing device. The determination of relevance may be based in whole or in part upon a match between user demographic conditions associated with a particular piece of information in proximity of the user and personal demographic information associated with the user of the portable computing device as stored within a user information database upon the SAI server 100 or stored within a personal data file upon the portable computing device or some other external server location. Similarly, the determination of relevance may be based in whole or in part upon a match between user specific conditions associated with a particular piece of information in proximity of the user and personal identification information and/or personal group membership information and/or personal password information associated with the user of the portable computing device as stored within a user information database upon the SAI server 100 or stored within a personal data file upon the portable computing device or some other external server location. Similarly, the determination of relevance may be based in whole or in part upon a match between weather conditions and/or temporal conditions associated with a particular piece of information in proximity of the user and current weather information and/or time-of-day information and/or day-of-week information for the current location of the portable computing device as determined by the locative sensors upon the portable computing device. Similarly, the determination of relevance may be based in whole or in part upon a match between descriptive tags associated with a particular piece of information in proximity of the user and current user information preference information for the user of the portable computing device that indicates a type, category, classification, or other identification of particular information search desires of the user. Such current user information preferences may be entered by the user through the user interface of the portable computing device and may be stored within the portable computing device and/or stored within the SAI server 100 and/or stored in an externally accessible memory location. In this way, the relevance of a particular piece of information may be determined with respect to a particular user. The relevance may be based upon a combination of factors and may result in a relevance value that quantifies a degree of relevance of the particular piece of information to the particular user.

Based upon the determination of relevance and/or the determination of a relevance value for a piece of information that is within a certain proximity of the user, the software running upon the microprocessor 410 of the portable computing device 111 can be configured to control the actuator (or actuators) to impart a unique alert sensation upon the user that indicates relevance to the user. The “relevance alert” sensation, for example, may be constructed as a sinusoidal varying force applied for 3000 milliseconds and a frequency of 60 HZ, thereby being of longer duration and higher frequency than a “basic alert” sensation. The sensation may also be impulse wave shaped such that an initial impulse accentuates the onset of the sensation for increased perceptual impact. In some embodiments, the parameters of the relevance alert sensation may be dependent upon the computed relevance value for the particular piece of information, for example the higher the relevance value the higher the frequency of the vibration sensation. Similarly, the relevance alert sensation may be imparted such that the higher the computed relevance value, the higher the magnitude of the vibration sensation. Similarly, the relevance alert sensation may be imparted such that the higher the computed relevance value, the longer the duration of the vibration sensation. In such ways, the user may be informed by the unique sensation that a piece of spatially associated information of high relevance is present within a certain proximity to the user. Furthermore, the user may be informed by the variable magnitude, frequency, and/or duration of the sensation as to the degree of relevance of the spatially associated information. In addition, the profile of the haptic sensation may be selected and/or modified based upon the particular match between the factors mentioned above. For example, if the type of information is geological a different unique sensation form may be imparted as compared if the type of the information is commercial.

User Specific Alert Sensation—software running upon the microprocessor 410 of the portable computing device 111 can be configured to control the actuator (or actuators) to impart a unique sensation that is perceptually different from other sensations imparted by the system when it is determined that spatially associated information is within a certain proximity of the particular user as the user wanders a real physical space and that the information is specifically intended for that particular user and/or is specifically intended for a group of users that includes the particular user. The determination that the information is intended for a particular user or a group of users two whom the particular user is a member may be based upon a match between user specific conditions associated with a particular piece of information in proximity of the user and personal identification information and/or personal group membership information and/or personal password information associated with the user of the portable computing device. Such personal identification information and/or personal group membership information and/or personal password information associated with the user is generally stored within either a user information database upon the SAI server 100 or within a personal data file upon the portable computing device or some other secure external server location.

Based upon the determination that a particular piece of spatially associated information is within a certain proximity of a particular user and is specifically intended for that particular user and/or is specifically intended for a group of users that includes the particular user as a member, the software running upon the microprocessor of the portable computing device can be configured to control the actuator (or actuators) to impart a unique alert sensation upon the user that indicates the user specific nature of the information to the user. The “user specific alert” sensation, for example, may be constructed as three bursts of sinusoidal varying force, each applied for 1000 milliseconds and separated by 750 milliseconds of off-time. This triple burst sensation may be imparted with the sinusoidally varying force being at a frequency of 87 HZ. The sensation may also be impulse wave shaped such that an initial impulse accentuates the onset of the sensation for increased perceptual impact. In some embodiments, a different sensation is imparted based upon the specificity of the user specific information. For example, if the user is the only person for whom a piece of information is intended, a higher magnitude and/or higher frequency and/or longer duration sensation may be imparted upon the user as compared to a piece of information for which the user is one of thousands of people for whom the information is intended. In this way, the user may be alerted not just to the user specific nature of a piece of spatially associated information but also be alerted to the degree of specificity by which that user was identified.

High Importance Alert Sensation—software running upon the microprocessor 410 of the portable computing device 111 can be configured to control the actuator (or actuators) to impart a unique sensation that is perceptually different from other sensations imparted by the system when it is determined that spatially associated information is within a certain proximity of the user as the user wanders a real physical space and that the information is of a high importance level as indicated by a descriptive tag associated with the information in the SAI database. The spatially associated information might be, for example, a danger warning posted by an authority that is associated with a high importance level to ensure that visitors view and consider the warning information. For example, the importance level might be assigned a value of 8 on a scale of one to ten as an indication of relative importance as compared to other information. Upon coming within a certain proximity of the spatially associated information as determined based upon the locative sensor data on board the portable computing device, software running upon the microprocessor 410 of the portable computing device 111 can be configured to control the actuator (or actuators) to impart a unique alert sensation upon the user that indicates the presence and the high importance of the information. The “high importance alert” sensation, for example, may be constructed as two bursts of saw-tooth wave varying force, each applied for 1500 milliseconds and separated by 800 milliseconds of off-time. This double burst sensation may be imparted with the saw-tooth wave varying force being at a frequency of 77 HZ. The vibration sensation may also be impulse wave shaped such that an initial impulse accentuates the onset of the sensation for increased perceptual impact. In some embodiments, the magnitude, frequency, and/or duration parameters of the importance alert sensation may be dependent upon the importance level assigned to that piece of information. For example, the higher the importance level value the higher the frequency of the vibration sensation and/or the higher the magnitude of the vibration sensation and/or the longer the duration of the vibration sensation. In such ways, the user may be informed by the unique sensation that a piece of spatially associated information of high importance is present within a certain proximity to the user. Furthermore, the user may be informed by the variable magnitude, frequency, and/or duration of the sensation as to the degree of importance of the spatially associated information.

In some embodiments, the importance level associated with a particular piece of information may be dependent upon other factors associated with the spatially associated information. For example, a warning message “Caution Black Ice” may be linked to a particular spatial location and/or spatial area upon a walking path in a national park that tends to get sheeted with black ice when the temperatures are below a certain level. The spatially associated warning message may be linked to a high importance level, for example a level 9 on a scale of one to ten, within the SAI database. The spatially associated warning message may also be linked to a weather condition such that users are only alerted to the message and/or granted access to the message if the current outdoor temperature is below 38 degree Fahrenheit. In this way, users who wander the path and come within a certain proximity of the black-ice prone patch will be alerted to the spatially associated warning message, for example by being hit with a High Importance Alert Sensation, but only if the current outdoor temperate is below 38 degrees. Thus, when the weather is too warm for black ice the system does not trigger an alert and/or provide access to that particular piece of information.

Multi-Trigger Alert Sensation—sometimes, a user may come across single spatial locations and/or single spatial areas that are associated with a plurality of different pieces of spatially associated information, each of which would generate an alert upon the user. For example, a particular street corner may have many different pieces of information that would trigger an alert for a particular user when he or she comes within a certain proximity. Because it could be confusing and/or distracting to impart a plurality of alert sensations upon the user, some embodiments, are configured to impart a single sensation upon the user that indicates to the user that multiple alerts have been triggered. Such a “multi-trigger alert” sensation may be configured as a unique sensation that is perceptually different from other sensations imparted by the system that is imparted when it is determined a plurality of different pieces of spatially associated information is within a certain proximity of the user, each of which the user should be alerted to. The “multi-trigger alert” sensation, for example, may be constructed as four bursts of sinusoidal wave varying force, each applied for 800 milliseconds and separated by 500 milliseconds of off-time. This quadruple burst sensation may be imparted with the sine wave varying force being at a frequency of 100 HZ. The vibration sensation may also be impulse wave shaped such that an initial impulse accentuates the onset of the sensation for increased perceptual impact.

In some embodiments, the magnitude, frequency, number of bursts, and/or duration parameters of the multi-trigger alert sensation may be dependent upon the number of distinct pieces of information for which the user is to be alerted to. For example, the higher the number of pieces of information the higher the frequency of the vibration sensation and/or the higher the magnitude of the vibration sensation and/or the longer the duration of the vibration sensation and/or the greater the number of bursts within the profile of the sensation. In such ways, the user may be informed by the unique sensation that a plurality of pieces of spatially associated information are present within a certain proximity to the user. Furthermore, the user may be informed by the variable magnitude, frequency, profile, and/or duration of the sensation as to the number of pieces of spatially associated information.

Registration: In some embodiments, users use a web browser (running on a computing device) to register online for the managed SAI service that is provided by a system operator who administers the system, manages information access, manages the SAI server 100, operates the SAI application, maintains the SAI database, and/or coordinates information exchange with location-based establishments. In particular, the system operator runs at least one SAI server 100 that associates information with spatial locations within the physical world. In some embodiments the SAI server 100 also maintains information about individual users, including for example demographic information and/or preference information as described previously. The SAI server 100 typically performs this function by maintaining and/or has access to a user database which contains personal demographic characteristics and/or preference information about each user indexed by a unique ID. In this way, the SAI server 100 can access demographic characteristics and/or preferences about each user from the SAI server 100 by referencing the unique ID value. Thus, such embodiments of the system operate as follows: the SAI server 100 receives current spatial location data (i.e. GPS coordinates) for a particular user various points in time along with a unique ID for that user. By using such data (e.g., GPS coordinates and the unique user ID), the SAI server 100 accesses stored data and determines if there is spatially associated information within a certain proximity of the user that is relevant and/or likely to be of interest to that particular user. If so an alert is generated.

The SAI server 100 interfaces to a telecommunications network through a gateway, such as a message gateway. Whether a user of a particular portable computing may gain access to the SAI server 100 depends in some embodiments upon that user being a registered user of the SAI service. As used herein, the term “portable computing device” refers broadly to any mobile wireless client device, e.g., a cell phone, pager, a personal digital assistant (PDA, e.g., with GPRS NIC), a mobile computer with a smartphone client, or the like. A typical portable computing device is a wireless access protocol (WAP)—enabled device that is capable of sending and receiving data in a wireless manner using the wireless application protocol. The wireless application protocol (“WAP”) allows users to access i information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In one embodiment, mobile device users use SMS, which is a text message service that enables short messages (e.g., generally no more than 140-160 characters in length) to be sent and transmitted from a portable computing device. Embodiments described herein are not limited to mobile device users who have WAP-enabled devices or to use of any particular type of wireless network. Such devices and networks are merely illustrative; any wireless data communication technology now known or hereafter developed may be used in connection with the embodiments described herein.

Software Modules: As described throughout this document, circuitry (e.g., software) may be employed (e.g., in the form of one or more different software modules) to implement various functionalities described herein. In one embodiment, a SAI server 100 software application runs upon the SAI server 100, a SAI client application circuitry is supported by client computing devices such as portable computing devices. The functionality of these various and different software modules have been described in detail throughout this document.

As exemplarily described above, several embodiments are adapted to provide real-time alerts in ways that do not require the user to be constantly looking at a screen upon the portable computing device and thereby distract the user from the real physical world in which they are traversing. For example, some embodiments are adapted to provide real-time alerts through sensory modalities that are not visually or aurally intrusive or distracting to the user.

As also exemplarily described above, several embodiments are adapted to provide real-time alerts to users as they walk about a physical space, the real time alerts being provided to inform the user that they have come within a certain proximity of a piece of spatially associated information that they may be interested in and/or a piece of information that is specifically relevant to them. For example, some embodiments are adapted to provide real-time alerts in ways that do not require the user to be constantly looking down at a screen upon the portable computing device that is monitoring the presence of spatially associated information. In another example, some embodiments are adapted to provide real-time alerts that are not visually or aurally intrusive or distracting.

As also exemplarily described above, several embodiments are adapted to provide intelligent methods by which a proximity region is defined around a user, the proximity region being the area within which spatially associated information triggers an alert to the user. Such embodiments may be adapted to predictively shape a region around a user and thereby alert the user to spatially associated information they are more likely to be interested in. Such embodiments, when implemented in accordance with the teachings provided herein, improve the usability and effectiveness of systems for providing user access to spatially associated information.

While many of the exemplary alerts and conditional alerts disclosed herein are described as tactile sensations, it should be noted that the methods and apparatus for triggering alerts disclosed herein may be implemented with visual alerts, audio alerts, tactile alerts, and/or any combination thereof.

While embodiments exemplarily described herein have been disclosed by means of specific examples and applications thereof, numerous modifications and variations could be made thereto by those skilled in the art without departing from the scope of the invention set forth in the claims.

What is claimed is:

1. A cuing method, comprising:
receiving current locative data, the locative data identifying a geographic position of a user's portable computing device and a direction of motion of the portable computing device;
defining a shape of a proximity region around the geographic position according to the direction of motion of the portable computing device;
accessing a database containing a plurality of information files, each of the plurality of information files being linked with a location;
determining whether a location to which an information file is linked is within the proximity region; and
transmitting a message to the portable computing device when a location linked to an information file is within the proximity region, the message adapted to alert a user via the portable computing device as to the presence of the information file.

2. The cuing method of claim 1, wherein defining the shape of the proximity region comprises distorting a reference shape of the proximity region in accordance with the direction of motion.

3. The cuing method of claim 2, wherein distorting the reference shape comprises extending the reference shape in the same direction as the direction of motion of the portable computing device.

4. The cuing method of claim 3, wherein the locative data further identifies a speed of motion of the portable computing device; and
distorting the reference shape further comprises extending the reference shape by an amount corresponding to the speed of motion.

5. The cuing method of claim 2, wherein distorting the reference shape comprises shrinking the reference shape in a direction opposite to the direction of motion of the portable computing device.

6. The cuing method of claim 5, wherein
the locative data further identifies a speed of motion of the portable computing device; and
distorting the reference shape further comprises shrinking the reference shape in the opposite direction by an amount corresponding to the speed of motion.

7. The cuing method of claim 2, wherein distorting the reference shape comprises shrinking the reference shape in a direction orthogonal to the direction of motion of the portable computing device.

8. The cuing method of claim 7, wherein
the locative data further identifies a speed of motion of the portable computing device; and
distorting the reference shape further comprises shrinking the reference shape in the orthogonal direction by an amount corresponding to the speed of motion.

9. The cuing method of claim 2, wherein distorting the reference shape comprises extending the reference shape in a direction orthogonal to the direction of motion of the portable computing device.

10. The cuing method of claim 9, wherein
the locative data further identifies a speed of motion of the portable computing device; and
distorting the reference shape further comprises extending the reference shape by an amount corresponding to the speed of motion.

11. The cuing method of claim 1, wherein the locative data further identifies a speed of motion of the portable computing device, the cuing method further comprising:
defining a size of the proximity region around the user's portable computing device according to the speed of motion of the portable computing device.

12. The cuing method of claim 1, wherein defining the size of the proximity region comprises defining at least one of an area or a volume of the proximity region.

13. The cuing method of claim 1, wherein the message is adapted to cause the portable computing device to provide a tactile alert to the user.

14. The cuing method of claim 1, wherein the message is adapted to cause the portable computing device to provide an audio alert to the user.

15. The cuing method of claim 1, wherein the message is further adapted to inform the user via the portable computing device as to at least one of the type, importance, relevance, and proximity of the information file.

16. The cuing method of claim 1, wherein the user is alerted only if the direction of motion satisfies a directional mobility condition associated with the information file.

17. A cuing method, comprising:
receiving current locative data, the locative data identifying a geographic position of a user's portable computing device and a speed of motion of the portable computing device;
defining a size of a proximity region around the geographic position according to the speed of motion of the portable computing device;
accessing a database containing a plurality of information files, each of the plurality of information files being linked with a location;
determining whether a location to which an information file is linked is within the proximity region; and
transmitting a message to the portable computing device when a location linked to an information file is within the proximity region, the message adapted to alert a user via the portable computing device as to the presence of the information file.

18. The cuing method of claim 17, wherein defining the size of the proximity region comprises defining at least one of an area or a volume of the proximity region.

19. The cuing method of claim 17, wherein the message is adapted to cause the portable computing device to provide a tactile alert to the user.

20. The cuing method of claim 17, wherein the message is adapted to cause the portable computing device to provide an audio alert to the user.

21. The cuing method of claim 17, wherein the message is further adapted to inform the user via the portable computing device as to at least one of the type, importance, relevance, and proximity of the information file.

22. The cuing method of claim 17, wherein the user is alerted only if the speed of motion satisfies a speed-related mobility condition associated with the information file.

23. A cuing system, comprising:
circuitry adapted to:
receive current locative data, the locative data identifying a geographic position of a user's portable computing device and a direction of motion of the portable computing device;
define a shape of a proximity region around the geographic position according to the direction of motion of the portable computing device;
access a database containing a plurality of information files, each of the plurality of information files being linked with a location;
determine whether a location to which an information file is linked is within the proximity region; and
transmit a message to the portable computing device when a location linked to an information file is within the proximity region, the message adapted to alert a user via the portable computing device as to the presence of the information file.

24. The cuing system of claim 23, wherein the message is adapted to alert the user only if the direction of motion satisfies a directional mobility condition associated with the information file.

25. The cuing system of claim 23, wherein the circuitry is adapted to define the shape of the proximity region by distorting a reference shape of the proximity region in accordance with the direction of motion.

26. The cuing system of claim 25, wherein the circuitry is adapted to distort the reference shape by extending the reference shape in the same direction as the direction of motion of the portable computing device.

27. The cuing system of claim 26, wherein
the locative data further identifies a speed of motion of the portable computing device; and
the circuitry is adapted to distort the reference shape by extending the reference shape by an amount corresponding to the speed of motion.

28. The cuing system of claim 25, wherein the circuitry is adapted to distort the reference shape by shrinking the reference shape in a direction opposite to the direction of motion of the portable computing device.

29. The cuing system of claim 28, wherein
the locative data further identifies a speed of motion of the portable computing device; and
the circuitry is adapted to distort the reference shape by shrinking the reference shape by an amount corresponding to the speed of motion.

30. The cuing system of claim 25, wherein the circuitry is adapted to distort the reference shape by shrinking the reference shape in a direction orthogonal to the direction of motion of the portable computing device.

31. The cuing system of claim 30, wherein
the locative data further identifies a speed of motion of the portable computing device; and
the circuitry is adapted to distort the reference shape by shrinking the reference shape by an amount corresponding to the speed of motion.

32. The cuing system of claim 25, wherein the circuitry is adapted to distort the reference shape by extending the reference shape in a direction orthogonal to the direction of motion of the portable computing device.

33. The cuing system of claim 32, wherein
the locative data further identifies a speed of motion of the portable computing device; and
the circuitry is adapted to distort the reference shape by extending the reference shape by an amount corresponding to the speed of motion.

34. The cuing system of claim 23, wherein
the locative data further identifies a speed of motion of the portable computing device; and
the circuitry is further adapted to define a size of the proximity region around the user's portable computing device according to the speed of motion of the portable computing device.

35. The cuing system of claim 23, wherein the circuitry is adapted to define the size of the proximity region by defining at least one of an area or a volume of the proximity region.

36. The cuing system of claim 23, wherein the message is adapted to cause the portable computing device to provide a tactile alert to the user.

37. The cuing system of claim 23, wherein the message is further adapted to inform the user via the portable computing device as to at least one of the type, importance, relevance, and proximity of the information file.

38. A cuing system, comprising:
circuitry adapted to:
receive current locative data, the locative data identifying a geographic position of a user's portable computing device and a speed of motion of the portable computing device;
define a size of a proximity region around the geographic position according to the speed of motion of the portable computing device;
access a database containing a plurality of information files, each of the plurality of information files being linked with a location;
determine whether a location to which an information file is linked is within the proximity region; and
transmit a message to the portable computing device when a location linked to an information file is within the proximity region, the message adapted to alert a user via the portable computing device as to the presence of the information file.

39. The cuing system of claim 38, wherein the message is adapted to alert the user only if the speed of motion satisfies a speed-related mobility condition associated with the information file.

40. The cuing system of claim 38, wherein the circuitry is adapted to define the size of the proximity region by defining at least one of an area or a volume of the proximity region.

41. The cuing system of claim 38, wherein the message is adapted to cause the portable computing device to provide a tactile alert to the user.

42. The cuing system of claim 38, wherein the message is adapted to cause the portable computing device to provide an audio alert to the user.

43. The cuing system of claim 38, wherein the message is further adapted to inform the user via the portable computing device as to at least one of the type, importance, relevance, and proximity of the information file.

44. A cuing system comprising a portable computing device with circuitry adapted to:
determine a current geospatial position and direction of motion;
access a database containing a plurality of information files, each of the plurality of information files being linked with one or more geospatial locations, each of the plurality of information files also being linked with a directional mobility condition; and
alert a user of the portable computing device when a location linked to a particular information file is within a proximity region around the current geospatial position and when the current direction of motion satisfies the directional mobility condition linked to that information file.

45. The cuing system of claim 44, wherein the size of the proximity region is determined at least in part based upon a current speed of motion of the portable computing device.

46. The cuing system of claim 44, wherein the shape of the proximity region is determined at least in part based upon the current direction of motion.
